(19) United States
(12) Patent Application Publication
(10) Pub. No.: US 2004/0026842 A1
(43) Pub. Date: Feb. 12, 2004

(54) Flexible fixturing apparatus

(76) Inventors: Peter M. Beecherl, Shelby Township, MI (US); Philip S. Szuba, Algonac, MI (US); Jairam Manjunathaiah, Warren, MI (US); Keller J. McGaffey, Troy, MI (US); Floyd P. Crelley, Fenton, MI (US); Shreyes N. Melkote, Roswell, GA (US)

Correspondence Address: REISING, ETHINGTON, BARNES, KISSELLE, P.C., P O BOX 4390, TROY, MI, 48099-4390, US

(21) Appl. No.: 10/216,372

(22) Filed: Aug. 9, 2002

(51) Int. Cl. B25B 1/24

(52) U.S. Cl. 269/266

(57) ABSTRACT

A flexible fixturing apparatus for securely holding and positively locating a workpiece for manufacturing operations. The apparatus includes a two-dimensional pin array comprising parallel pins movably supported on a housing for individual reciprocal axial motion toward contact with a workpiece to be supported. A pin locking mechanism releasably locks the pins of the first pin array against axial motion relative to the housing once the pins have contacted and conformed to the shape of a workpiece. The pin locking mechanism includes a first clamp supported in the housing for reciprocal motion toward and away from the pin array such that panel motion towards the pin array presses the pins of the array against a pin retaining wall of the housing. A second clamp is supported in the housing for reciprocal motion toward and away from the pin array. Motion of the second clamp towards the pin array locks the pins more securely by further crowding the pins. Motion of both the first and second clamps away from the array more fully releases the pins for subsequent axial repositioning than moving only a single clamp.

### BACKGROUND OF THE INVENTION

1. Field of the Invention

This invention relates generally to a flexible fixturing apparatus for securely holding and positively locating a workpiece for subsequent manufacturing operations such as machining and assembly.

2. Description of the Related Art Including Information Disclosed Under 37 CFR 1.97 and 1.98

Flexible fixturing apparati for securely holding and positively locating workpieces for manufacturing operations are known in the art. Also known are such fixturing apparati that include two-dimensional arrays of parallel pins movably supported for individual reciprocal axial motion to conform to the shape of a portion of an outer surface of a workpiece to be supported.

For example, U.S. Pat. No. 5,407,185 issued Apr. 18, 1995 to Zehnpfennig et al., discloses a flexible fixturing apparatus that includes two opposing two-dimensional arrays of parallel pins. The pins of each array are movably supported on a housing for individual reciprocal axial motion inward toward and outward away from the housing. The arrays are disposed axially opposite one another such that outward motion of pins from the one array opposes outward motion of pins of the other array. The flexible fixturing apparatus of the Zehnpfennig et al. patent also includes a pin actuator operatively coupled to each pin of the two arrays. The pin actuator drives the pins inward toward respective stowed positions and outward toward respective extended positions and into contact with a workpiece positioned between the arrays.

The Zehnpfenning et al. apparatus also includes a pin locking mechanism that releasably locks the pins of the two arrays against axial motion relative to their respective housings. In each housing, the pin locking mechanism includes a clamp supported for reciprocal motion toward and away from a pin array. Motion of the clamp toward a pin array crowds the pins of the array against a generally U-shaped pin retaining wall including three perpendicular surfaces. However, a flexible fixturing apparatus constructed according to the Zehnpfennig et al. patent may not fully release the pins after clamping. This is because tight tolerances between pins crowded between the three fixed retaining wall surfaces can tend to over-constrain the pins causing them to bind. Upon release, pins can hang-up, preventing free relative axial motion between them and between the pins and the constraining walls. The Zehnpfennig et al. pin locking mechanism is also unable to lock the pins without supplying pneumatic pressure to actuate a clamp mechanism. Still further, the Zehnpfennig et al. pin locking mechanism requires a bulky air cylinder-driven lever arm to generate sufficient clamping pressure on the pins.

In addition, U.S. Pat. No. 4,047,709 issued to Thyberg et al. Sep. 13, 1977 discloses a clamping fixture including a housing, movable plungers, and metal balls for locking the plungers in a fixed position. The balls are forced against ribbed intermediate sections of each plunger to lock the plungers against longitudinal motion.

U.S. Pat. No. 4,572,564 issued Feb. 25, 1986 to Cipolla discloses a robotic gripper employing opposing jaws with movable plungers or pins. Actuation of a pneumatically operated mechanism moves the jaws together to grasp an object and depresses the pins until they conform to the shape of the object. Springs force balls against the pins to lock the pins against longitudinal motion. The pins can be unlocked by raising a plate which allows the balls to fall out of contact with the pins.

U.S. Pat. No. 5,690,323 issued Nov. 25, 1997 to Puttmer shows a pair of opposed workpiece gripping jaws, each of which comprises an array of pins. The pins are extended and locked against the surface of a workpiece by hydraulic pressure.

U.S. Pat. No. 5,988,618 issued Nov. 23, 1999 to Meintrup et al. shows a work holding device for printed circuit boards that comprises an array of pins. The pins can be locked in place by a force applied against a movable wall or by a pressure piece acting against such a wall. Similarly, U.S. Pat. No. 5,984,293 issued Nov. 16, 1999 to Abrahamson et al. shows a device for holding printed circuit boards that includes a cam lever that forces a lock plate against an array of pins to lock the pins against perforated plates.

### BRIEF SUMMARY OF THE INVENTION

The invention is a flexible fixturing apparatus for securely holding and positively locating a workpiece so that manufacturing operations can be carried out on the workpiece. The apparatus includes a first two-dimensional pin array comprising parallel pins movably supported on a first housing for individual reciprocal axial motion inward toward stowed positions in the first housing and outward from the first housing toward respective extended positions and into contact with a workpiece to be supported. The flexible fixturing apparatus also includes a pin locking mechanism engageable with the first pin array and configured to releasably lock the pins of the first pin array against axial motion relative to the first housing. The pin locking mechanism includes a first clamp supported in the first housing for reciprocal motion toward and away from the first pin array such that motion of the clamp toward the first pin array presses the pins of the first pin array against a pin retaining wall of the first housing. The flexible fixturing apparatus also includes a second clamp supported in the first housing for reciprocal motion toward and away from the first pin array such that motion of the second clamp toward the first pin array further crowds the pins of the first pin array against the pin retaining wall of the first housing. The second clamp locks the pins more securely against displacement caused by machining forces applied to a supported workpiece. The second clamp also more fully releases the pins for axial repositioning. Releasing two walls along nonparallel axes more fully releases the pins for subsequent relative axial motion than the release of a single wall.

According to another aspect of the invention, a shuttle is supported on the housing adjacent the first clamp for reciprocal motion perpendicular to the reciprocal motion of the first clamp. A mechanical linkage couples the shuttle to the first clamp and is configured to convert reciprocal shuttle motion into reciprocal motion of the first clamp. A shuttle drive is connected to the shuttle and is configured to drive the shuttle through its reciprocal motion. This arrangement moves the first clamp plate in and out of engagement with the pins while requiring very little space to do so.

According to yet another aspect of the invention the first clamp is spring biased toward the first pin array and the pin locking mechanism is configured to alternately pull the first clamp away from the first pin array against the spring bias and to release the first clamp into engagement with the first pin array. As such, power is only required to unlock the pins and the flexible fixturing apparatus can be transported between machining stations with a workpiece securely mounted on the apparatus.

The invention also includes a method for securely holding and positively locating a workpiece for machining. The method includes providing a workpiece between the first and second pin arrays of the fixturing apparatus, then axially extending the pins of the first and second pin arrays until they either contact the workpiece or reach respective fully extended positions. The pins are then locked in their positions against the workpiece by moving the two clamps in each housing against their respective pin arrays. The apparatus is then moved to one or more manufacturing stations for manufacturing operations to be carried out on the workpiece supported between the pin arrays. The pins are then released by moving the two clamps in each housing away from their respective pin arrays.

Objects, features and advantages of this invention include providing a flexible fixturing apparatus that can more securely hold and positively locate workpieces of varying configurations, that locks the axially movable pins of opposing two-dimensional pin arrays more securely against displacement that might otherwise be caused by machining forces applied to a workpiece supported between the arrays, that requires no external power to maintain the lock, and that more fully releases such pins for axial repositioning when the lock is released.

### BRIEF DESCRIPTION OF THE DRAWINGS

These and other objects, features and advantages of this invention will be apparent from the following detailed description of the preferred embodiment(s) and best mode, appended claims, and accompanying drawings in which:

FIG. 1 is a perspective view of a flexible fixturing apparatus constructed according to the invention shown supported on a configuration station, engaged by an actuation device constructed according to the invention, and supporting a workpiece between axially-opposed pin arrays of the fixturing apparatus;

FIG. 2 is an isometric view of the flexible fixturing apparatus of FIG. 1 with the workpiece removed;

FIG. 3 is a fragmentary cross-sectional front view of the fixturing apparatus of FIG. 2 shown housing a gearbox, coupling, driveshaft, and ballscrew of the apparatus;

FIG. 4 is an isometric view of two pin arrays supported in a housing of the fixturing apparatus of FIG. 2;

FIG. 5 is an isometric exploded view of the housing of FIG. 4 with a top plate, seal plate, and all but one pin removed for clarity;

FIG. 6 is a partially cut-away fragmentary isometric view of the housing of FIG. 5;

FIG. 7 is a front view of the actuation device of FIG. 1; and

FIG. 8 is a cutaway view of a servo-actuator coupling of the actuation device of FIG. 7.

### DETAILED DESCRIPTION OF INVENTION EMBODIMENT(S)

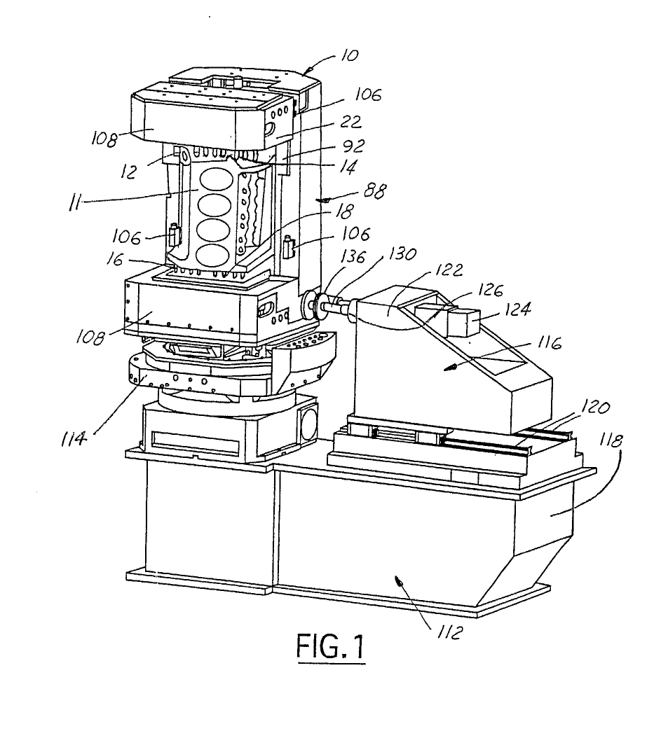

A flexible fixturing apparatus for securely holding and positively locating a workpiece is shown in the drawings. As shown in FIG. 1, the fixturing apparatus 10 holds a single workpiece 11 at a time, securely enough to allow machining, assembly, and other types of manufacturing operations to be carried out on the workpiece 11. Most broadly described, the apparatus 10 includes axially opposing two-dimensional pin arrays 12, 14, 16, 18 as shown in FIGS. 1, 2 and 4. Each array comprises a plurality of parallel axially-movable pins 20. Two of the arrays 12, 14 are supported on an upper housing 22 and the other two arrays 16, 18 are supported on a lower housing 24. In each array, the pins 20 are supported for individual reciprocal axial motion inward toward stowed positions in their respective housings 22, 24 and outward from their housings 22, 24 toward respective extended positions. In moving toward their respective extended positions the pins 20 are arranged to come into contact with and be arrested in their axial motion by a workpiece 11 supported between the upper and lower housings 22, 24. The apparatus 10 also includes a pin locking mechanism 26 that includes elements that engage the pins 20 of each pin array 12, 14, 16, 18 and releasably lock the pins 20 against axial motion relative to their respective housings 22, 24. For each array 12, 14, 16, 18, the pin locking mechanism 26 includes a first clamp 28 supported in the corresponding housing for reciprocal motion toward and away from the pin array such that clamp motion towards the pin array presses on and crowds the pins 20 of the array against a pin retaining wall 30 of the housing. For each array 12, 14, 16, 18, the pin locking mechanism 26 also includes a second clamp 32 supported in the corresponding housing for reciprocal motion toward and away from the array such that clamp motion toward the pin array presses on the pins 110 from a different direction and further crowds the pins 20 of the pin array against the pin retaining wall 30 of the housing. The second clamp 32 locks the pins 20 more securely against displacement caused by machining or other manufacturing forces applied to a supported workpiece 11. The withdrawal of a second clamp 32 also serves to more fully release the pins 20 for axial repositioning than would be possible by withdrawing only a single clamp. The release or withdrawal of two clamps along non-parallel axes more fully releases the pins 20 for subsequent relative axial motion. This is because tolerances around the pins 20 are tight, and the locking of the pins 20 by crowding can cause the pins 110 to bind or hang-up.

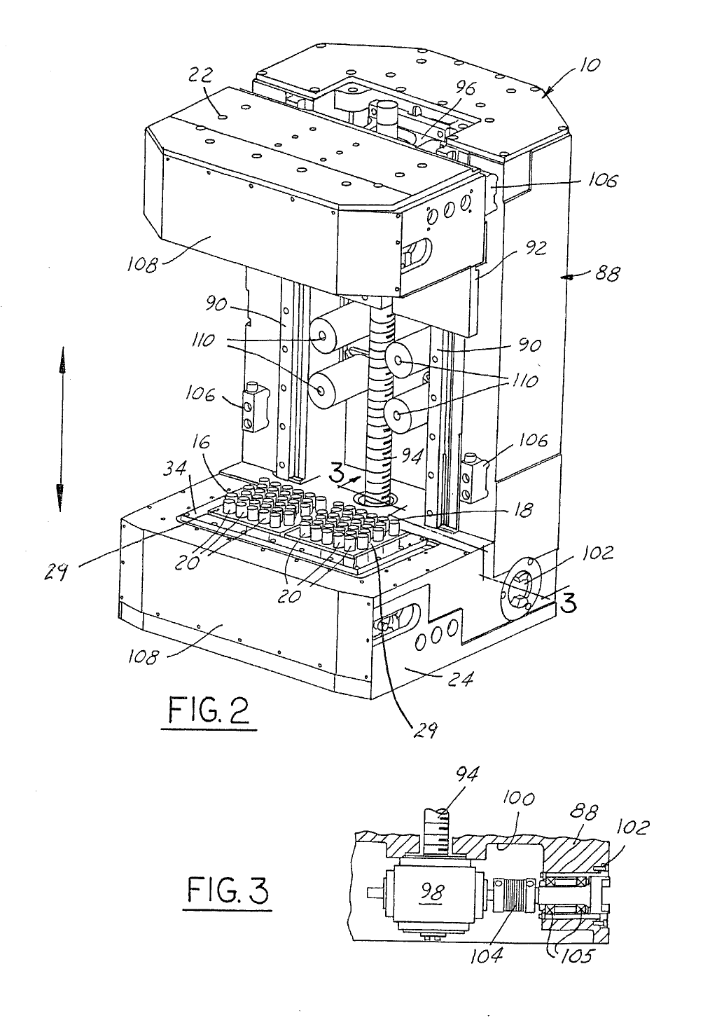

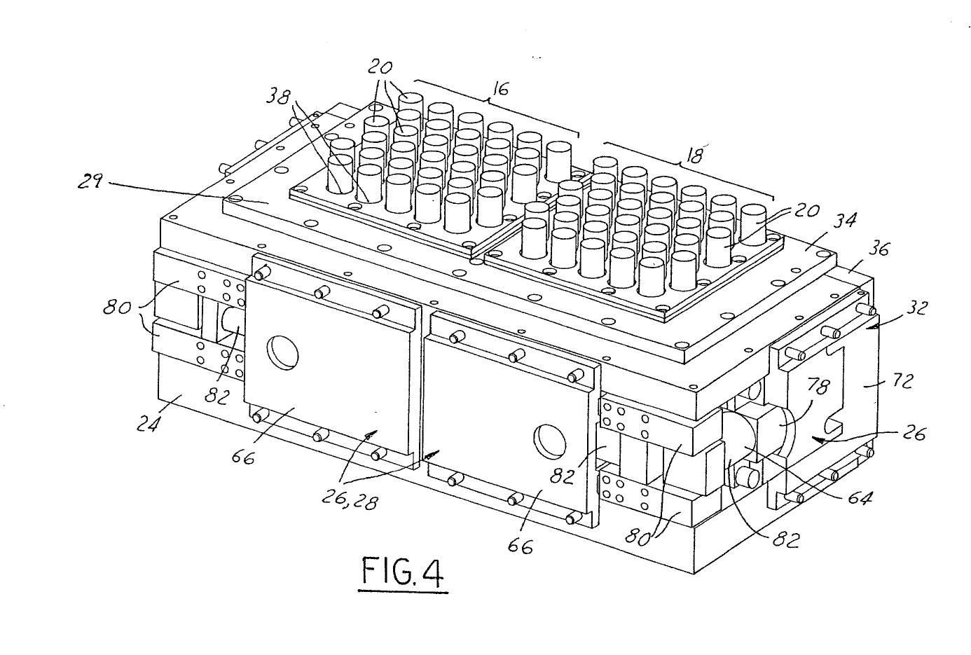

As shown in FIGS. 2 and 4, each of the four arrays 12, 14, 16, 18 includes thirty-three pins 20. The pins 20 of each array 12, 14, 16, 18 are trapped in one of two pin cavities 40 in each housing 22, 24. Besides retaining the pins 20, the housings 22, 24 also include mounting features for assembly with other components of the flexible fixturing apparatus 10.

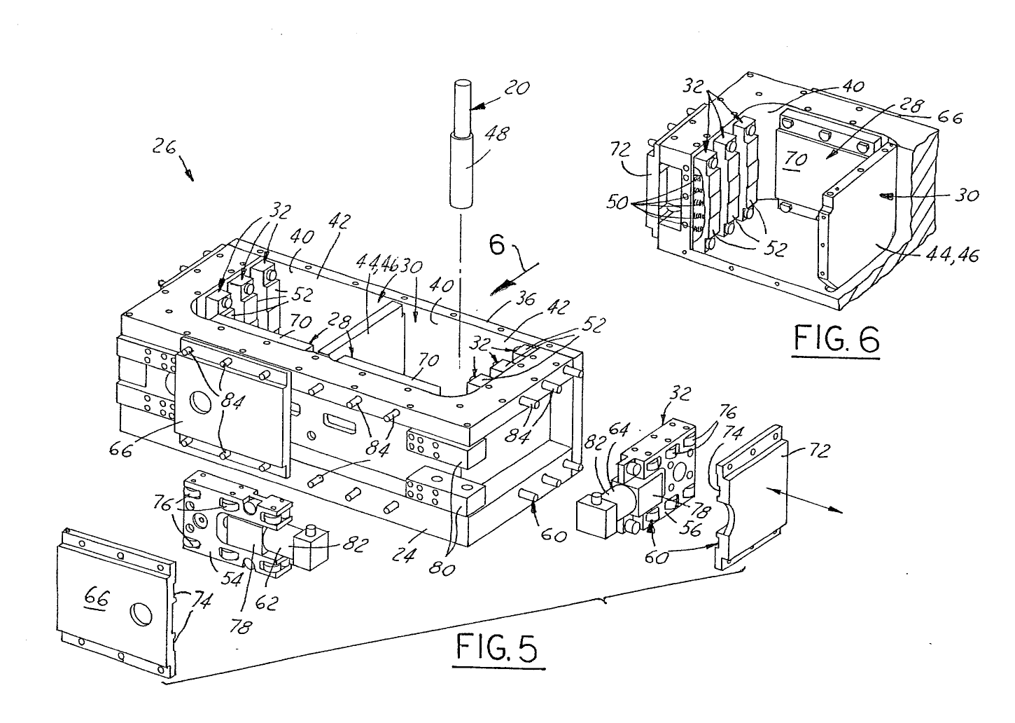

Attached to each housing 22, 24 are a top plate shown at 34 in FIG. 4 and a back wall shown at 36 in FIGS. 4 and 5. The top plate 34 of each housing 22, 24 serves as a guide for the pins 20. As such, holes in each top plate 34 have diameters slightly larger than the diameters of the pins 20. In addition to guiding the pins 20, the top plates 34 increase the stiffness of their respective housings 22, 24. The back wall 36 of each housing provides additional mounting features for assembly with the rest of the apparatus 10 and partly define the pin cavities 40. To keep contaminates out of the housings 22, 24, standard lip seals 38 are supported around the holes in the top plates 34 to seal against the pins 20. Each pin extends through two seal plates 29 that attach to each top plate 34.

As shown in FIG. 5, each housing 22, 24 includes two pin cavities 40, each of which is partially defined by the back wall 36 that also defines one of two retaining wall surfaces 42, 44 of the pin retaining wall 30 for each of the two cavities 40. The two retaining wall surfaces 42, 44 of each retaining wall 30 are generally rectangular in shape and are disposed generally perpendicular to one another and generally opposite and parallel to the respective first and second clamps 28, 32. While a back retaining wall surface 42 of each cavity 40 is formed by the back wall 36, a side retaining wall surface 44 of each cavity 40 is formed by a center dividing wall 46 of each housing 22, 24. The reciprocal motions of the first and second clamps 28, 32 for each pin array 12, 14, 16, 18 are directed toward and away from the respective back and side retaining wall surfaces 42, 44 such that the second clamp 32 acts on the pin array in a direction generally perpendicular to the direction the first clamp 28 acts on the pin array. The combined resultant clamping action thus crowds the pins 110 of each pin array 12, 14, 16, 18 into a corner formed by the two perpendicular retaining wall surfaces 42, 44 rather than against a single retaining wall surface.

As shown in FIG. 5, the pins 20 have bases 48 with larger stepped diameters forming shoulders that limit the upward stroke of the pins 28. The larger stepped diameters also provide circumferential clamping surfaces for the locking mechanism 26. When the pin locking mechanism 26 is locked, all the pins 20 in each pin array 12, 14, 16, 18 are forced into the back and side retaining wall surfaces 42, 44 of the cavity 40 the pin array is housed in. The normal forces applied generate frictional forces greater than combined clamp and cutting forces that the pins 20 will be subjected to.

This normal force is generated by a series of springs representatively shown at 50 in FIG. 6. The springs 50 mount between each clamp 28, 32 and its corresponding housing. The pins 20, retainer walls, and clamps 28, 32 are held to tight assembly tolerances. These tolerances provide significant friction between the pins even after the locking mechanism 26 is released. The second clamp 32 is included to obviate the need to use a large amount of force to break the pins loose after clamping. When both clamps 28, 32 are retracted along different axes the pins 20 are allowed to move more freely than if only a single clamp was retracted along a single axis.

As best shown in FIG. 4, the pins 20 of each pin array 12, 14, 16, 18 are arranged in six generally parallel and co-extensive pin rows, with alternate rows being staggered so that the pins 20 can be packed more tightly together. The second clamp 32 includes three clamp pads shown at 52 in FIGS. 5 and 6. The clamp pads 52 are aligned with three of the six pin rows that have pins 20 disposed closest to the pads 52. The motion of each clamp pad 52 toward the pin array is directed toward and is aligned with one of those three pin rows. This arrangement provides even pressure on each row despite any differences that might exist in the distances between the pads 52 and the closest pins 20 in their corresponding pin rows.

In each pin array 12, 14, 16, 18, the bases 48 of the pins 110 are supported for axial motion within the pin cavity 40 and are movable axially outward by providing pressurized air in the pin cavity 40. The pins 20 are drawn inward by providing negative air pressure in the pin cavity 40.

For each pin array 12, 14, 16, 18 the pin locking mechanism 26 comprises a first shuttle block 54 supported on the housing adjacent the first clamp 28 for reciprocal motion perpendicular to the reciprocal motion of the first clamp 28. Similarly, a second shuttle block 56 is supported on the housing adjacent the second clamp 32. As shown in FIG. 5, first and second mechanical linkages 58, 60 couple the first and second shuttle blocks 54, 56 to the first and second clamps 28, 32, respectively, for each array 12, 14, 16, 18 and convert reciprocal shuttle motion into reciprocal clamp motion. First and second shuttle drives 62, 64 are connected to the respective first and second shuttle blocks 54, 56 and drive the shuttle blocks 54, 56 through their reciprocal motions. The shuttle blocks 54, 56; mechanical linkages 58, 60; and shuttle drives 62, 64 therefore facilitate the movement of the clamps 28, 32 in and out of engagement with the pins 20 while requiring very little space to do so.

For each pin array, the first mechanical linkage 58 includes a first cam plate 66 fixed in a parallel disposition to and spaced from a generally planar clamp plate 70 of the first clamp 28 and supported for reciprocal motion with the first clamp 28 on the housing. Similarly, the second mechanical linkage 60 includes a second cam plate 72 fixed in a parallel disposition to and spaced from the three clamp pads 52 of the second clamp 32. Six cams are disposed in cam tracks 74 on each cam plate 66, 72 and six corresponding roller-type cam followers 76 are rotatably supported in and protrude from a side of each shuttle block 54, 56 facing the respective cam plates 66, 72. Interaction between the cams in the cam tracks 74 of the cam plates 66, 72 and the cam followers 76 of the shuttle blocks 54, 56 due to reciprocal motion of the shuttle blocks 54, 56 drives reciprocal motion of the clamps 28, 32 perpendicular to the reciprocal motion of the shuttle blocks 54, 56. Each shuttle block 54, 56 actually houses fourteen standard cam followers, but only the six indicated at 76 act against cam surfaces. The remaining eight of those cam followers 76 run against flat surfaces of the housing to reduce sliding friction of the shuttle blocks 54, 56.

The clamps 28, 32 are spring biased toward their respective pin arrays 12, 14, 16, 18 and their corresponding shuttle drives 62, 64; mechanical linkages 58, 60; and shuttle blocks 54, 56 cooperate to alternately pull the clamps 28, 32 away from their respective pin arrays against the spring bias and to release the clamps 28, 32 into engagement with their respective pin arrays. As such, power is only required to unlock the pins 20 and the flexible fixturing apparatus 10 can be transported, unpowered, between machining stations with a workpiece 11 remaining securely mounted on the apparatus 10.

Each shuttle drive 62, 64 includes a hydraulic cylinder 78 that mounts to two trunnion blocks 80 on one end and includes a movable rod 82 connected to one of the shuttle blocks 54, 56. The trunnion blocks 80 mount directly to the housing.

For each array, the second cam plate 72 is attached to the three clamp pads 52 of the second clamp 32 by six studs 84 that are guided by the housing via precision holes. As the cylinder 78 is actuated, the second shuttle block 56 moves toward the trunnion block 80, which forces the second cam plate 72 to move outward from the housing as the followers 76 roll on an angled cam track 74 in the plate 72. As the second cam plate 72 moves outward, it pulls the clamp pads 52 away from the pins 110 and eliminates the normal force that the pads 52 had been exerting on the pins 20.

Once this normal force is eliminated, the clamp plate 70 of the first clamp 28 must be retracted. It is retracted in a manner similar to the retraction of the clamp pads 52 of the second clamp 32 by the hydraulic cylinder 78 that drives the first shuttle block 54. The first cam plate 66 for each array is attached to the clamp plate 70 of the first clamp 28 by six studs 84 that are guided by the housing via precision holes. The first shuttle block 54 is trapped between the housing 24 and the first cam plate 48 with the cam followers 76 contacting both. As the cylinder 78 is actuated, the first shuttle block 54 moves toward the trunnion blocks 80 which forces the first cam plate 66 to move outward from the housing 24 as the followers 76 roll on the cam surfaces 74 formed in the plate 66. As the first cam plate 66 moves outward, it pulls the clamp plate 70 away from the pins 20 creating clearance around pins 20 allowing them to move freely.

The pin arrays 16, 18 supported on the lower housing 24 are disposed axially opposite the respective pin arrays 12, 14 supported on the upper housing 22. As such, downward motion of pins 20 of the pin arrays 12, 14 from the upper housing 22 opposes upward motion of pins 20 of the pin arrays on the lower housing 24. The upper housing 22 is supported on a column 88 for vertical reciprocal motion toward and away from the lower housing 24 so that workpieces 11 of different sizes can be accommodated between the opposing pin arrays.

As shown in FIG. 2, two linear guide rails 90 mount in a vertical orientation on the column 88. A carriage 92 mounted on the guide rails 90 supports the upper housing 22 for its vertical reciprocal motion. To generate the vertical motion of the carriage 92 and the upper housing 22, a ballscrew 94 is connected to the carriage 92. The ballscrew 94 is supported at an upper end by a bearing assembly 96 that attaches directly to the column 88. As is best shown in FIG. 3, a lower end of the ballscrew 94 is supported and driven by the output side of a 90° gearbox 98 that mounts in a cavity 100 formed in a bottom end of the column 88. A drive shaft 102 mounts in the side of the column 88 and connects to the input side of the gearbox 98 by a standard coupling 104. The drive shaft 102 is supported in the fixturing apparatus 10 by two radial ball bearings 105. The ballscrew 94 and gear box 98 were designed such that an upward force will not be able to back-drive the ballscrew and gearbox, thereby reducing the clamp force on the workpiece 11. To control the upper and lower travel limits of the carriage 92, hard stops 106 are mounted to the column 88. Metal covers 108 protect the pin arrays 12, 14, 16, 18 from debris associated with machining operations.

The apparatus 10 also includes four workpiece backup pins shown at 110 in FIG. 3. The backup pins 110 are movably supported on the column 88. The backup pins 110 individually and retractably extend outward into contact with a workpiece 11 held between the pin arrays of the upper housing 22 and the pin arrays of the lower housing 24. The motion of the backup pins 110 is generally perpendicular to the reciprocal motion of the upper housing 22 relative to the lower housing 24. Extension of the backup pins 110 into contact with a workpiece 11 clamped between the pin arrays of the upper and lower housings 22, 24 limits or prevents workpiece 11 deflection that might otherwise be caused by application of machining forces or other forces encountered in various manufacturing processes. The backup pins 110 are driven outward by positive air pressure and retracted by negative air pressure. Clamping units are supported on the column adjacent each backup pin and mechanically lock the backup pins 110 in respective positions contacting a workpiece 11. As such, removal of pressurized air will not allow or cause the pins 110 to retract.

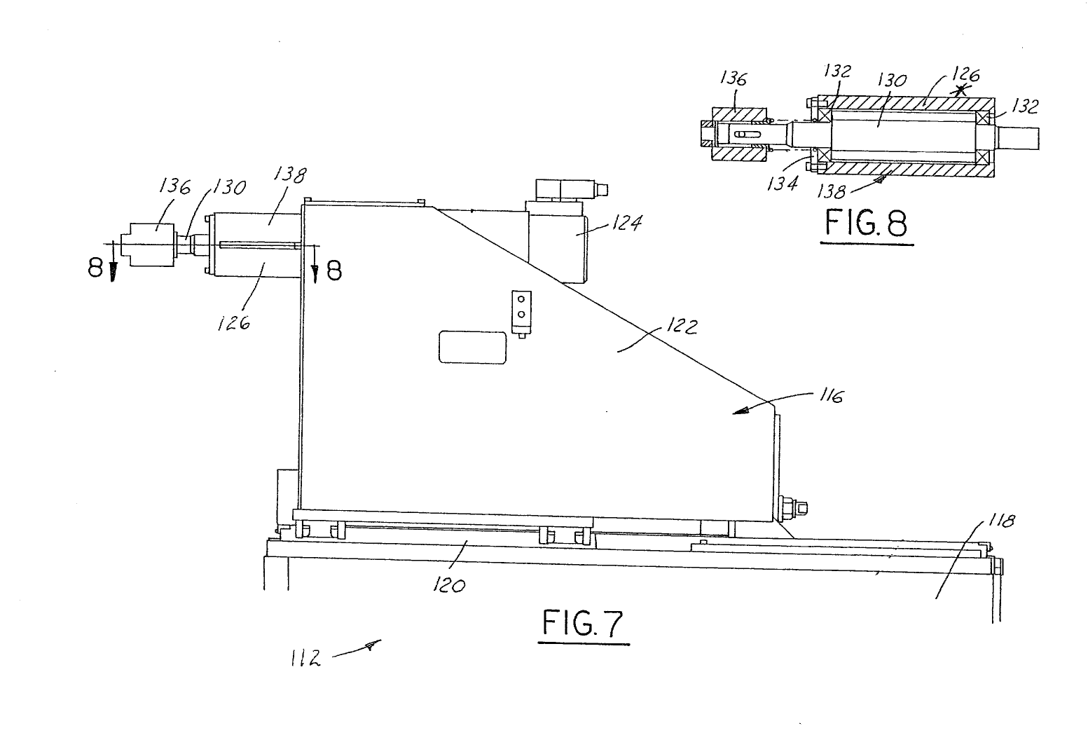

To reduce the overall cost of the flexible fixturing apparatus 10, there is no onboard power and there are no internal actuators. Instead, the actuation and power required to operate the flexible fixturing apparatus 10 are provided at a configuration station such as the one shown at 112 in FIG. 1. The apparatus 10 mounts to a machine pallet or micro-positioner 114 at the configuration station 112 as shown in FIG. 1. As is also shown in FIG. 1 the configuration station 112 includes an actuation device 116 that drives the reciprocal motion of the carriage 92 of the fixturing apparatus 10. As best shown in FIG. 7, the actuation device 116 includes a base 118 on which a set of linear ball rails 120 is mounted. A column portion 122 of the actuation device 116 mounts to movable portions of the ball rails 120 and is advanced into engagement with and withdrawn from engagement with a flexible fixturing apparatus 10 by a hydraulic cylinder (not shown). One end of the hydraulic cylinder connects to the base 118 and an opposite end of the cylinder connects to the column 122. A servo actuator 124 mounts to the top of the column 122 and rotatably engages a drive shaft 130 rotatably supported in a shaft housing 126. As best shown in FIG. 8, a drive shaft assembly 138 of the coupling 126 comprises the drive shaft 130, two radial bearings 132, a bearing retainer 134, and a fixturing apparatus coupling 136. This assembly 138 is received in the drive shaft housing 138 on a front side of the column 122. When the column 122 is advanced toward the flexible fixturing apparatus 10, the fixturing apparatus coupling 136 engages the drive shaft 102 on the fixturing apparatus 10. Then, as the servo 124 rotates the coupling 136 in a first rotational direction, the carriage 92 moves down and applies clamp force on a workpiece 11 positioned between the arrays 12, 14, 16, 18. As the servo 124 rotates the coupling 136 in a second direction opposite the first rotational direction, the carriage 92 moves up and releases clamp force from the workpiece 11.

In practice, the apparatus 10 is used to securely hold and positively locate a workpiece 11 for subsequent machining operations by first loading the fixturing apparatus 10 onto a configuration station 112. The actuation device 116 is then advanced toward the fixturing apparatus 10 until the coupling 136 of the actuation device 116 engages the drive shaft 102 of the fixturing apparatus 10. The servo 124 of the actuation device 116 is then rotated to move the carriage 92 of the fixturing apparatus 10 to its uppermost position against the upper hard stops 106 adjacent the top of the fixturing apparatus 10. Simultaneously, the pin arrays 12, 14, 16, 18 are unlocked by actuating the hydraulic pressure cylinders 78 that release the clamp pads 52 of the second clamp 32 bearing on each array, then actuating the hydraulic cylinders 78 that release the clamp panel 70 of the first clamp 28 bearing on each array. The pins 110 of the four pin arrays 12, 14, 16, 18 are then retracted by applying negative air pressure to the four cavities 40 housing the bases of those pins 110. The backup pins 110 are then unlocked and air pressure is applied to retract them. A workpiece 11 is then manually or automatically positioned between the upper and lower housings 22, 24 of the fixturing apparatus 10 with the workpiece 11 being held slightly above the pin arrays 16, 18 that are supported in the lower housing 24.

The carriage 92 is then lowered to a predetermined position for the workpiece 11 being fixtured by causing the actuation device 116 to rotate the servo actuator 124. The pins 20 of the four pin arrays 12, 14, 16, 18 are then axially extended by providing positive air pressure in the four pin cavities 40. Positive air pressure is supplied to the cavities until the pins 20 have all either contacted and conformed to the shape of the workpiece 11, or have missed contact and reached respective fully extended positions. At this point the pins 20 are locked in their positions against the workpiece 11 by moving the two clamps 28, 32 in each housing 22, 24 against their respective pin arrays. The clamps 28, 32 are advanced by releasing hydraulic pressure from the cylinders that hold the clamps open.

To lock the pins 110, the clamp panel of the first clamp 28 in each cavity 40 is first moved against its corresponding pin array. The clamp pads 52 of the second clamp 32 are then moved against the pin array. The clamp panel of the first clamp 28 is moved first so that the pins 110 are pushed into rows more closely aligned with the clamp pads 52 of the second clamp 32 before advancing the clamp pads 52.

Once the pins 20 have been locked, an axial clamping force is applied to the workpiece 11 through the pin arrays by rotating the servo actuator 124 to lower the carriage 92 down the column 88. A predetermined torque variable programmed into a servo controller determines the amount of axial force applied to a particular type of workpiece 11. Positive air pressure is then applied to the backup pins 20 to cause them to advance against the workpiece 11. The backup pins 20 are then locked in position.

All power sources and external drives 62, 64, such as the actuation device 116 and pneumatic pressure sources, are then removed and/or disconnected from the fixturing apparatus 10. The fixturing apparatus 10 is then moved from the configuration station 112 to one or more manufacturing and/or machining stations for manufacturing and/or machining operations to be carried out on the workpiece 11 supported between the pin arrays.

The fixturing apparatus 10 is then returned to the configuration station 112 to be unloaded and reconfigured with either the same workpiece 11 in a new orientation of a completely different workpiece 11. To remove the workpiece 11 the backup pins 20 are first unlocked and are then retracted by application of negative air pressure. The pins 20 of the four pin arrays are then unlocked by moving the two clamps 28, 32 in each pin cavity 40 away from their respective pin arrays. More specifically, the clamp pads 52 of the second clamp 32 are first withdrawn, then the clamp panel of the first clamp 28 are retracted.

The flexible fixturing apparatus 10 allows for flexible clamping and holding of various workpieces for manufacturing operations. It's capable of holding a variety of workpieces in multiple orientations without the use of fixed locators or clamping points. Therefore, it eliminates the need for non-functional features that are normally added to workpieces for manufacturing purposes. Removing these features will, in most cases, reduce the overall cost of a given workpiece 11. The apparatus 10 does not require any onboard actuators or power supply systems, which reduces the cost of producing each flexible fixturing apparatus 10. The fixturing apparatus 10 is also compact in size so that it will fit onto any machine tool having a standard 630 mm pallet while maintaining adequate static and dynamic stiffness for high force machining operations.

This description is intended to illustrate certain embodiments of the invention rather than to limit the invention. Therefore, it uses descriptive rather than limiting words. Obviously, it's possible to modify this invention from what the description teaches. Within the scope of the claims, one may practice the invention other than as described.

We claim:

1. A flexible fixturing apparatus for securely holding and positively locating a workpiece so that manufacturing operations can be carried out on the workpiece, the apparatus comprising:
a first two-dimensional pin array comprising parallel pins movably supported on a first housing for individual reciprocal axial motion inward toward respective stowed positions in the first housing and outward from the first housing toward respective extended positions and into contact with a workpiece to be supported;
a pin locking mechanism engageable with the first pin array and configured to releasably lock the pins of the first pin array against axial motion relative to the first housing, the pin locking mechanism including:
a first clamp supported in the first housing for reciprocal motion toward and away from the first pin array such that panel motion toward the first pin array presses the pins of the first pin array against one or more pin retaining wall surfaces of the first housing, and
a second clamp supported in the first housing for reciprocal motion toward and away from the first pin array such that panel motion toward the first pin array further crowds the pins of the first pin array against the one or more pin retaining wall surfaces of the first housing to lock the pins more securely against displacement caused by machining forces applied to a supported workpiece and to more fully release them for axial repositioning.

2. A flexible fixturing apparatus as defined in claim 1 in which:
the first housing includes first and second pin retaining wall surfaces fixed in a generally perpendicular relationship to one another and generally opposite and parallel to the respective first and second clamps; and
the reciprocal motions of the first and second clamps are directed toward and away from the respective first and second retaining wall surfaces such that the second clamp acts on the first pin array in a direction generally perpendicular to the direction the first clamp acts on the first pin array.

3. A flexible fixturing apparatus as defined in claim 2 in which:
the pins of the first pin array are arranged in at least two generally parallel and co-extensive pin rows; and
the second clamp comprises at least two individually-actuable clamp pads aligned with the respective pin rows such that the motion of each clamp pad toward the first pin array is directed toward and is aligned with one of the two pin rows.

4. A flexible fixturing apparatus as defined in claim 2 in which:
the first housing includes a pin cavity defined, in part, by the pin retaining wall surfaces;
the base ends of the pins of the first pin array are supported for axial motion within the pin cavity;
the pins of the first pin array are movable outward by providing pressurized air in the pin cavity; and
the pins of the first pin array are movable inward by providing negative air pressure in the pin cavity.

5. A flexible fixturing apparatus for securely holding and positively locating a workpiece so that manufacturing operations can be carried out on the workpiece, the apparatus comprising:
a first two-dimensional pin array comprising parallel pins movably supported on a first housing for individual reciprocal axial motion inward toward respective stowed positions in the first housing and outward from the first housing toward respective extended positions and into contact with a workpiece to be supported;
a pin locking mechanism engageable with the first pin array and configured to releasably lock the pins of the first pin array against axial motion relative to the first housing, the pin locking mechanism including:
a first clamp supported in the first housing for reciprocal motion toward and away from the first pin array such that panel motion toward the first pin array presses the pins of the first pin array against one or more pin retaining wall surfaces of the first housing; and
a shuttle supported on the housing adjacent the first clamp for reciprocal motion perpendicular to the reciprocal motion of the first clamp;
a mechanical linkage coupling the shuttle to the first clamp and configured to convert reciprocal shuttle motion into reciprocal motion of the first clamp; and
a shuttle drive connected to the shuttle and configured to drive the shuttle through its reciprocal motion.

6. A flexible fixturing apparatus as defined in claim 5 in which:
the mechanical linkage includes a first cam plate fixed in a parallel disposition to and spaced from a generally planar clamp plate of the first clamp and supported for reciprocal motion with the first clamp on the housing;
at least one cam is disposed on one of the first cam plate and the shuttle; and
at least one cam follower is supported on the other of the first cam plate and the shuttle such that interaction of the cam and cam follower due to reciprocal shuttle motion drives reciprocal motion of the first clamp that is perpendicular to the reciprocal shuttle motion.

7. A flexible fixturing apparatus as defined in claim 5 in which:
the first clamp is spring biased toward the first pin array; and
the mechanical linkage is configured to alternately pull the first clamp away from the first pin array against the spring bias and to release the first clamp into engagement with the first pin array.

8. A flexible fixturing apparatus for securely holding and positively locating a workpiece so that manufacturing operations can be carried out on the workpiece, the apparatus comprising:
a first two-dimensional pin array comprising parallel pins movably supported on a first housing for individual reciprocal axial motion inward toward respective stowed positions in the first housing and outward from the first housing toward respective extended positions and into contact with a workpiece to be supported; and
a pin locking mechanism engageable with the first pin array and configured to releasably lock the pins of the first pin array against axial motion relative to the first housing, the pin locking mechanism including a first clamp supported in the first housing for reciprocal motion toward and away from the first pin array such that panel motion toward the first pin array presses the pins of the first pin array against one or more pin retaining wall surfaces of the first housing, the first clamp being spring biased toward the first pin array, the pin locking mechanism being configured to alternately pull the first clamp away from the first pin array against the spring bias and to release the first clamp into engagement with the first pin array.

9. A flexible fixturing apparatus as defined in claim 8 in which the pin locking mechanism comprises:
a shuttle supported on the housing adjacent the first clamp for reciprocal motion perpendicular to the reciprocal motion of the first clamp;
a mechanical linkage coupling the shuttle to the first clamp and configured to convert reciprocal shuttle motion into reciprocal motion of the first clamp and to alternately pull the first clamp away from the first pin array against the spring bias and to release the first clamp into engagement with the first pin array; and
a shuttle drive connected to the shuttle and configured to drive the shuttle through its reciprocal motion.

10. A flexible fixturing apparatus as defined in claim 1 and further including a second two-dimensional pin array comprising parallel pins movably supported on a second housing for individual reciprocal axial motion inward toward and outward away from the second housing, the second array being disposed adjacent the first pin array in a position to hold a workpiece between the first and second pin arrays.

11. A flexible fixturing apparatus as defined in claim 10 in which the second housing is supported on a column for reciprocal motion toward and away from the first housing.

12. A flexible fixturing apparatus as defined in claim 11 and further including a backup pin movably supported on the column to retractably extend outward into contact with a workpiece held between the first and second pin arrays, the backup pin motion being perpendicular to the reciprocal motion of the second housing relative to the first housing.

13. A flexible fixturing apparatus as defined in claim 12 in which the backup pin is configured to be driven outward by positive air pressure and retracted by negative air pressure.

14. A flexible fixturing apparatus as defined in claim 12 and further including a clamping unit supported on the column adjacent the backup pin and configured to mechanically and releasably lock the backup pin in a position contacting a workpiece.

15. A flexible fixturing apparatus as defined in claim 11 in which:
the second housing is supported on a carriage movably supported on the column to carry the second housing through its reciprocal axial motion; and
a mechanical drive linkage is connected to the carriage and is releasably connectable to a fixture actuation device configured to actuate the mechanical drive linkage to move the carriage through its reciprocal motion.

16. A method for securely holding and positively locating a workpiece so that manufacturing operations can be carried out on the workpiece, the method including the steps of:
providing a flexible fixturing apparatus comprising first and second axially opposed two-dimensional pin arrays, each comprising parallel pins movably supported on a housing for individual reciprocal axial motion, a pin locking mechanism configured to releasably lock the pins against axial motion relative to the housing and including a first clamp supported for reciprocal motion toward and away from the pin array such that panel motion toward the pin array presses the pins against a pin retaining wall, and a second clamp supported for reciprocal motion toward and away from the pin array to further crowd the pins against the retaining wall;
providing a workpiece between the first and second pin arrays of the fixturing apparatus;
axially extending the pins of the first and second pin arrays until they either contact the workpiece or reach respective fully extended positions;
locking the pins in their positions against the workpiece by moving the two clamps in each housing against their respective pin arrays;
moving the apparatus to one or more manufacturing stations for manufacturing operations to be carried out on the workpiece supported between the pin arrays; and
releasing the pins by moving the two clamps in each housing away from their respective pin arrays.

17. The method of claim 16 in which the step of locking the pins in their positions against the workpiece includes moving the clamp panel of the first clamp against the pin array before moving the clamp pads of the second clamp against the pin array.

18. The method of claim 16 including the additional step of causing at least one of the two housings to apply axial clamping force onto the workpiece through the opposing pin arrays following the step of locking the pins in their positions against the workpiece.

19. The method of claim 18 including the additional steps of:
providing a backup pin on a column that movably supports the second array with respect to the first array; and
advancing the backup pin against the workpiece after the step of applying axial clamping force onto the workpiece; and
locking the backup pin in position.

20. The method of claim 16 in which the step of releasing the pins includes moving the clamp pads of the second clamp away from the pin array before moving the clamp panel of the first clamp away from the pin array.
